(19) United States
(12) Patent Application Publication
(10) Pub. No.: US 2011/0287376 A1
(43) Pub. Date: Nov. 24, 2011

(54) Device For Circumdental Wiring Intraoral Objects And Related Oral Structures

(76) Inventor: Russell B. Walther, Dallas, TX (US)

(21) Appl. No.: 12/785,447

(22) Filed: May 22, 2010

(51) Int. Cl. A61C 7/02

(52) U.S. Cl. 433/3

(57) ABSTRACT

The present disclosure provides for a device for circumdental wiring intraoral objects and related oral structures during a dental procedure, the device includes a predetermined length of dental wire and a predetermined length of guiding member attached to the dental wire thereby increasing the efficiency of the dental procedure and the safety of a dental professional and patient during the dental procedure.

### DESCRIPTION OF THE DRAWINGS

FIG. 1 is a perspective view of a dental wire and a guiding member attached thereto comprising an embodiment of the present invention;

FIG. 2 is a perspective view of a dental wire having a loop protruding from an end thereof and a guiding member connected thereto comprising another embodiment of the present invention;

FIG. 3 is a perspective view of a dental wire and a guiding member joined thereto wherein a portion of the guiding member is embedded in the dental wire comprising another embodiment of the present invention;

FIG. 4 is a top view of a circumdental wiring procedure wherein a guiding member having a dental wire attached thereto is positioned at the interproximal space on each side of a tooth;

FIG. 5 is the procedure shown in FIG. 4 wherein the tip of the guiding member is pulled thereby causing the dental wire to pass through an interproximal space on one side of a tooth;

FIG. 6 is the procedure shown in FIG. 5 wherein the tip of the guiding member is pulled further thereby causing the dental wire to more substantially wrap around the tooth while substantially conforming to the contour of the tooth; and

FIG. 7 is a top view of an embodiment of the present invention that has been utilized in a dental procedure to secure an arch bar to teeth.

### DETAILED DESCRIPTION

For decades, dental wire has been utilized universally as a nexus between intraoral objects such as arch bars, arch wires, braces, appliances and/or teeth. Dental professionals and in particular professionals specializing the areas of orthodontics and oral surgery rely on dental wire to provide support and means of interconnectivity for parts and object of the mouth, oral cavity, maxillofacial area, soft and hard tissues of the mandible, as well as the adjacent and associated structures of the human body.

Its inherent strength coupled with its malleable characteristics make dental wire well suited for use in dental procedures. As such, it is often utilized in stabilizing and securing intraoral objects. For example, stabilization during reduction or fixation of fractured facial bones involving the teeth or maxillo-mandibular injuries entails the securing of each individual tooth to a splint or support bar shaped to an appropriate arch form. Accordingly, a predetermined length of dental wire is passed substantially around the circumference of a tooth in a process known as circumdental wiring. During this process, one end of the dental wire is pushed through the interproximal space between the teeth at or below the gum line. Then, the dental wire is positioned substantially around the tooth and is fastened about the splint or support bar, thereby providing stabilization.

The process of methodically circumdental wiring a tooth and fastening the dental wire about a splint or support bar is widely used in the field of dentistry. Because the dental wire must conform substantially to a tooth's circumference, readily allow its ends to be tightly twisted, and continuously retain the twist thereby holding an oral appliance in place, it must be soft and malleable. Therefore, the dental wire's properties must exhibit pliability but with a small degree of firmness to retain a twist. Utilizing such a wire has several disadvantages when circumdental wiring a tooth.

Among the many disadvantages of the current circumdental wiring practiced methodology is the trauma of the gum tissue that occasionally occurs to a patient when interdental gingiva is penetrated accidently during the procedure. Because the dental wire is malleable and may comprise a tip that is blunt, extra force exerted on the dental wire may be necessary to properly position the dental wire through the interproximal space between the teeth and substantially around the circumference of a tooth. Often, this extra force causes the dental wire to deflect from its intended path and to veer into the patient's interdental gingival, thus causing trauma.

Also, passing the dental wire through the interproximal space on one side of a tooth, positioning the wire substantially around the circumference of the tooth, and then passing the dental wire through the interproximal space on the other side of the tooth can be a tedious and time-consuming process. Moreover, since a patient orally may possess up to thirty two teeth and every tooth may require circumdental wiring, a dental professional can spend a substantial amount of time on this specific task. Thus, today's current circumdental wiring techniques are inefficient and a laborious undertaking. Neither the patient nor the dental professional is well-served by today's current circumdental wiring procedures.

Furthermore, occupational exposure can occur. Dental professionals frequently double or triple glove during the placement of the dental wire in the oral cavity due to the high risk of the procedure. Significant deflection of the dental wire can occur as it passes through the interproximal space between the teeth, thereby causing an end portion of the dental wire to move in a different direction than anticipated. As a result of this unanticipated movement, both dental professional and patient are at a considerably high risk of blood exposure due to the increased risk of puncture.

Embodiments of the present invention provide advantages to both dental professional and patient during a circumdental wiring procedure by permitting easier placement of a dental wire through the interproximal space between the teeth, increasing the efficiency of the procedure, substantially decreasing the amount of time expended by the dental professional during the procedure, and increasing the physical safety of the dental professional and patient by decreasing the occupational hazards. By affixing a guiding member to an end portion of the dental wire and utilizing the guiding member in conjunction with the dental wire during a circumdental wiring procedure, the aforementioned advantages can be realized. Other advantages will become apparent to a person of ordinary skill in this art upon a study of the present disclosure and associated drawings.

For a better understanding of the many embodiments of the present invention, drawings are included herewith. Referring to FIG. 1, a predetermined length of dental wire 100 is illustrated having an end portion 102. A guiding member 104 having a predetermined length is attached to an end portion 102 of the dental wire 100. A person of ordinary skill in the art will appreciate that the guiding member 104 exhibits many of the same or similar properties, characteristics, and traits of dental floss. Thus, the material composition of the guiding member 104 can be substantially similar to the material composition of dental floss.

For example, the guiding member 104, similar to dental floss, can be comprised essentially of a flexible elongated strip of material having adequate strength when wet to resist breaking when pulled back and forth in an interproximal space between the teeth or under a dental arch bar and sufficiently soft when wet to avoid piercing gum tissue or scratching intraoral objects. More specifically, the guiding member 104 can be comprised of a polymer such as nylon, polytetrafluoroethylene (PTFE), expanded polytetrafluoroethylene (ePTFE), or full density expanded polytetrafluoroethylene. Additionally, the guiding member 104 can be comprised of other such fibers such as but not limited to polyolefins (e.g. ultra high molecular weight polyethylene), polyamides, polyimides, polyurethanes, elastomeric material, polymer blends, or natural fibers.

The guiding member 104 can exist in one of several forms such as but not limited to a string form or ribbon form. Additionally, the guiding member 104 can include a coating such as wax or polyvinyl acetate.

The dental wire 100 can be of a type that is commonly used in the field of dentistry such as but not limited to a filament, monofilament, or multifilament wire or the like. The material composition of the dental wire 100 can constitute 316L stainless steel, metal alloy, plastic, polymer, etc.

As FIG. 1 illustrates, the guiding member 104 is attached to the dental wire 100 at an end portion 102 thereof. A person of ordinary skill in this art will appreciate the many embodiments of the present invention which include the differing ways that the guiding member 104 can be joined and/or connected to the dental wire 100. For example, the dental wire 100 and guiding member 104 can be attached via chemically bonding or adhesion such as glue or other chemical compound. The guiding member 104 can also be fastened to the dental wire 100 via a tie and/or hook

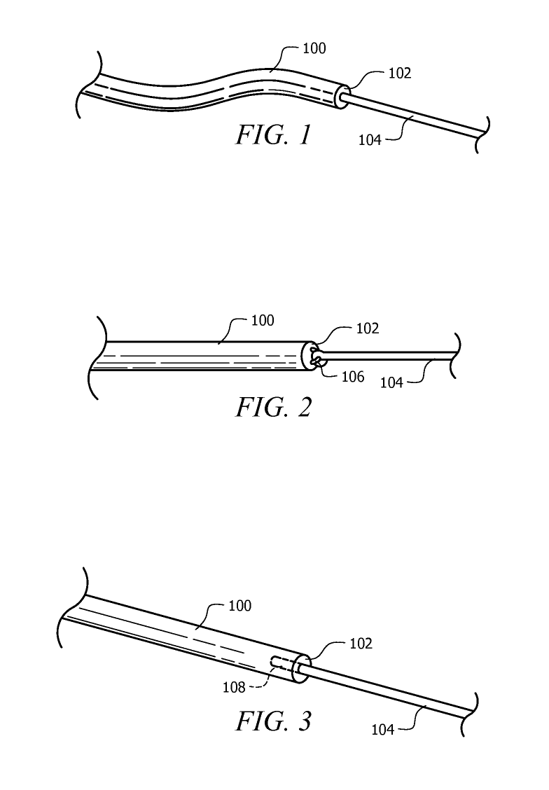

FIG. 2 illustrates another embodiment of the present invention. In this embodiment, a guiding member 104 having a predetermined length is fastened to a loop 106 protruding from an end portion 102 of a dental wire 100. The guiding member 104 is fastened by tying an end thereof to the protruding loop 106 at an end portion 102 of the dental wire 100 such that a knot fastens and secures the guiding member 104 to the dental wire 100. Various other similar embodiments are envisioned that employ other fasteners such as hooks, adhesions, etc.

FIG. 3 illustrates yet another embodiment of the present invention. In this embodiment, a guiding member 104 is embedded into a dental wire 100 and protrudes therefrom. Because the guiding member 104 is firmly embedded, it is securely joined to the dental wire 100.

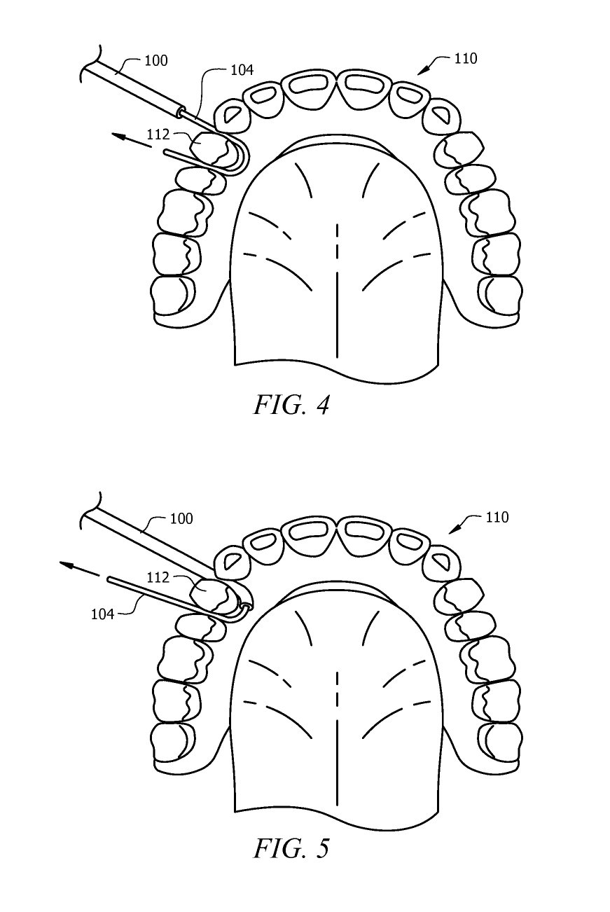

FIGS. 4, 5 and 6 illustrate the use of an embodiment of the present invention in a mouth 110 during a circumdental wiring procedure. In FIG. 4, a predetermined length of guiding member 104 having a dental wire 100 attached thereto is positioned around a tooth 112. As noted above, the guiding member 104 exhibits substantially the same properties, characteristics and traits of dental floss. As such, the guiding member 104 can be positioned in the interproximal spaces between the teeth using the same techniques, methods and procedures that a dental profession or patient would employ when using dental floss to expel food particles and tartar from the interproximal spaces between the teeth.

The tip of the guiding member 104 is positioned so that it is pointing in a direction opposite the mouth 110 and extends sufficiently away from the mouth 110 to enable a dental professional or other person to grasp it and pull in a direction opposite the mouth 110. A portion of the guiding member 104 is positioned in the interproximal space on one side of the tooth 112, around the backside of the tooth 112 and in the interproximal space on the other side of the tooth 112. Since, for example, the guiding member 104 exhibits floss-like abilities, a dental professional can quickly and easily force the guiding member 104 from the top of the tooth 112 toward the interproximal space thereof just as if the dental professional was attempting to floss the interproximal spaces of the tooth 112.

When the guiding member 104 is positioned substantially around the tooth 112 and in the interproximal spaces thereof, the tip of the guiding member 104 can be pulled in a direction opposite the mouth 110 as depicted in FIG. 5. When pulled, the guiding member 104 guides the dental wire 100 around the tooth 112 thereby circumdental wiring the tooth 112. As force is applied to the tip of the guiding member 104 and in the direction of the arrow, the dental wire 100 passes through the interproximal area located on one side of the tooth 112. In addition, the guiding member 104 forces the dental wire 100 to hug the contour of the tooth 112 thereby causing the dental wire 100 to fit snuggly around the tooth 112.

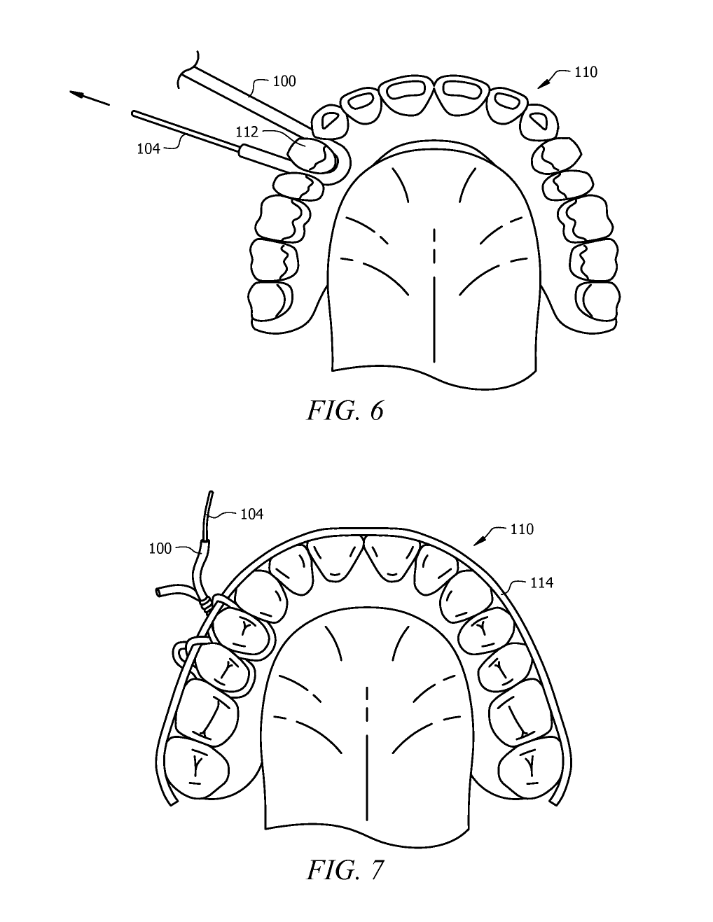

FIG. 6 illustrates the movement of the dental wire 100 as force is continually applied to the guiding member 104. By continually pulling the tip of the guiding member 104, the dental wire 100 passed through the interproximal spaces on each side of the tooth 112 and is substantially wrapped around the tooth 112. As a result, the circumdental wiring of tooth 112 is performed in a manner that is quick, safe and easy.

While embodiments of the present invention provide for an improved device for circumdentally wiring a tooth, it should be understood that the present invention applies to other dental procedures as well. For example, FIG. 7 illustrates a dental procedure for securing an arch bar 114 to teeth. As shown, a dental wire 100 and a guiding member 104 attached thereto are utilized to secure an arch bar 114 to teeth. FIG. 7 illustrates one of the many other utilities of the present invention.

The embodiments of the present invention apply to wires, regardless of type, function or properties, guiding members, regardless of type, function or properties, and dental procedures, regardless of type, method or function.

Although the embodiments of the invention has been illustrated in the accompanying Drawings and described in the foregoing Detailed Description, it should be understood that that the invention is not limited to the embodiments disclosed, but is capable of numerous rearrangements, modifications, and/or substitutions or parts and elements without departing from the spirit of the invention.

What is claimed is:

1. A device for circumdental wiring intraoral objects and related oral structures during a dental procedure, the device comprising:
a predetermined length of dental wire; and
a predetermined length of guiding member attached to the dental wire thereby increasing the efficiency of the dental procedure and the safety of a dental professional and patient during the dental procedure.

2. The device for circumdental wiring intraoral objects and related oral structures during a dental procedure of claim 1 wherein the dental wire is monofilament.

3. The device for circumdental wiring intraoral objects and related oral structures during a dental procedure of claim 1 wherein the dental wire is a metal alloy.

4. The device for circumdental wiring intraoral objects and related oral structures during a dental procedure of claim 1 wherein the guiding member comprises a flexible elongated strip of material having adequate strength when wet to resist breaking when pulled back and forth in an interproximal space between teeth and sufficiently soft when wet to avoid piercing gum tissue.

5. The device for circumdental wiring intraoral objects and related oral structures during a dental procedure of claim 1 wherein the material composition of the guiding member is substantially similar to the material composition of dental floss.

6. The device for circumdental wiring intraoral objects and related oral structures during a dental procedure of claim 1 wherein the guiding member comprises polytetrafluoethylene.

7. The device for circumdental wiring intraoral objects and related oral structures during a dental procedure of claim 1 wherein the guiding member comprises a string form.

8. The device for circumdental wiring intraoral objects and related oral structures during a dental procedure of claim 1 wherein a portion of the guiding member is embedded in a portion of the dental wire and protrudes therefrom.

9. The device for circumdental wiring intraoral objects and related oral structures during a dental procedure of claim 1 wherein the dental wire comprises a loop protruding therefrom.

10. The device for circumdental wiring intraoral objects and related oral structures during a dental procedure of claim 9 wherein the guiding member fastens to the loop.

11. The device for circumdental wiring intraoral objects and related oral structures during a dental procedure of claim 1 wherein the guiding member adheres to the dental wire.

12. A device for circumdental wiring intraoral objects and related oral structures during a dental procedure, the device comprising:
a predetermined length of dental wire; and
a predetermined length of guiding member; and
a means for attaching the guiding member to the dental wire thereby increasing the efficiency of the dental procedure and the safety of a dental professional and patient during the dental procedure.

13. The device for circumdental wiring intraoral objects and related oral structures during a dental procedure of claim 12 wherein the dental wire is monofilament.

14. The device for circumdental wiring intraoral objects and related oral structures during a dental procedure of claim 12 wherein the dental wire is a metal alloy.

15. The device for circumdental wiring intraoral objects and related oral structures during a dental procedure of claim 12 wherein the guiding member comprises a flexible elongated strip of material having adequate strength when wet to resist breaking when pulled back and forth in an interproximal space between teeth and sufficiently soft when wet to avoid piercing gum tissue.

16. The device for circumdental wiring intraoral objects and related oral structures during a dental procedure of claim 12 wherein the material composition of the guiding member is substantially similar to the material composition of dental floss.

17. The device for circumdental wiring intraoral objects and related oral structures during a dental procedure of claim 12 wherein the guiding member comprises polytetrafluoethylene.

18. The device for circumdental wiring intraoral objects and related oral structures during a dental procedure of claim 12 wherein the guiding member comprises a string form.

19. The device for circumdental wiring intraoral objects and related oral structures during a dental procedure of claim 12 wherein a portion of the guiding member is embedded in a portion of the dental wire.

20. The device for circumdental wiring intraoral objects and related oral structures during a dental procedure of claim 12 wherein a portion of the guiding member protrudes from the dental wire.
